(19) United States
(12) Patent Application Publication
(10) Pub. No.: US 2006/0091800 A1
(43) Pub. Date: May 4, 2006

(54) Light source and method for providing a transfer function for a chemical element in a light source

(75) Inventor: Jorg Arnold, Bern (CH)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: IP2H AG

(21) Appl. No.: 11/287,985

(22) Filed: Nov. 28, 2005

Related U.S. Application Data
(63) Continuation of application No. PCT/DE04/01066, filed on May 19, 2004.

(30) Foreign Application Priority Data
May 27, 2003 (DE) 103 24 361.5
Jul. 25, 2003 (DE) 103 34 365.2

(51) Int. Cl. H01K 1/50

(52) U.S. Cl. 313/578

(57) ABSTRACT

A light source with a heatable filament (1), wherein the filament (1) is arranged in a bulb (2), and wherein the bulb (2) contains a gas or a gas mixture, which is suited for providing a transfer function for returning again back to and/or into the filament at least one chemical element that has been released by the filament (1). The gas or the gas mixture contains an enrichment of oxygen and/or an oxygen-containing compound. Furthermore, a method is disclosed for providing a transfer function for a chemical element in a light source.

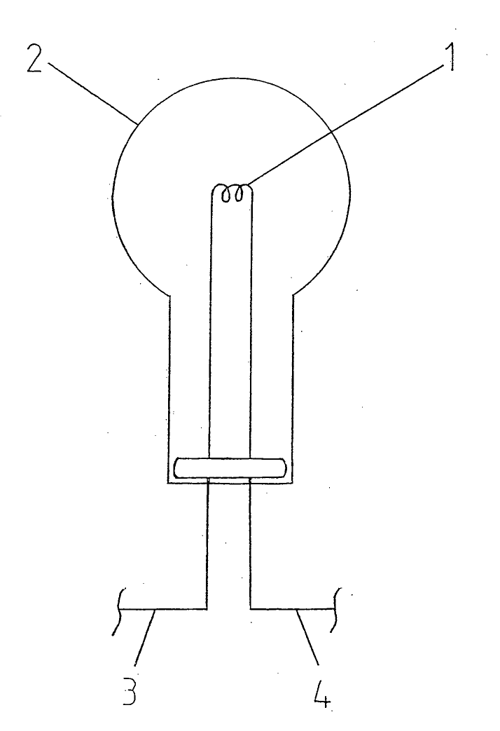

### CROSS REFERENCE TO RELATED APPLICATIONS

This is a continuation of copending international Application No. PCT/DE2004/001066 filed 19 May 2004 and designating the U.S. The disclosure of the referenced application is incorporated herein by reference.

### BACKGROUND OF THE INVENTION

The present invention relates to a light source with a heatable filament, wherein the filament is arranged in a bulb, and wherein the bulb contains a gas or a gas mixture which is suitable for providing a transfer function for returning again back to and/or into the filament at least one chemical element that has been released from the filament. Furthermore, the invention relates to a method of providing such a transfer function.

Light sources of the initially described type are known from practice and they exist in a great variety of designs and configurations. A known light source is, for example, an incandescent lamp which comprises an incandescent filament of a high-melting or refractory material, electrodes serving as connectors to hold the filaments, and a bulb that is filled with a gas mixture.

Currently, incandescent lamps have the lowest energetic efficiency within available lamp technologies. This means that they generate relatively much heat in comparison with the emission of light. On the other hand, however, they are illuminating bodies or light sources that can be produced in a most cost-favorable manner. It is therefore desirable to increase the energetic efficiency of incandescent lamps. This can be achieved by using as filament material, high-melting or refractory carbides, borides, nitrides, oxides or silicides. When being used, the most favorable and, therefore, most interesting metals of these compounds are with respect to their properties, hafnium, niobium, tantalum, zirconium, or alloys of these metal, for example, tantalum-hafnium. Especially suitable among these materials are carbides, in particular hafnium carbide and tantalum carbide, because of their excellent electrical conductivity and their high thermo-mechanical stability.

For example, when used for incandescent lamps, tantalum carbide has as a representative of the metal carbides a substantially higher applicable annealing temperature and, in addition, a higher selectivity or yield of the light emission in the visible range than tungsten that is normally used for incandescent lamps. Incandescent lamps with tantalum carbide filaments are able to reach substantially higher energetic efficiencies than tungsten filament lamps.

When using, for example, tantalum carbide as filament material at high temperatures, the greatest problem is its tendency to release carbon, thereby converting itself into less temperature stable tantalum carbide phases or even into metallic tantalum.

Incandescent lamps with a filament of high-melting materials, such as, for example, metal carbides, metal borides, metal silicides, and the like are disclosed in German Patent Application N 2038 VIIc/21f filed Jul. 26, 1961, and U.S. application Nos. 14253 and 14254 filed Mar. 11, 1960. Likewise, these Applications disclose a mass transfer cycle within the lamps, which operates with halogen compounds. In this process, it is possible to return again to the filament by means of the mass transfer cycle, evaporating filament material, such as, for example, carbon, boron or silicon. However, the known mass transfer cycles must occur either in a totally oxygen free or a totally hydrogen free atmosphere to achieve a suitable efficiency.

Known mass transfer cycles on the basis of halogen compounds have the disadvantage that during the operation of the lamps, elementary halogen can be released, which may attack and destroy the lamp bulb and the internal components of the lamp. It is therefore necessary to construct such light sources or lamps with correspondingly resistant coatings or materials, which makes production of such lamps considerably more expensive.

It is therefore an object of the invention to provide a light source as well as a method for providing a transfer function of the initially described type, wherein a high energetic efficiency is achieved with simple means.

### SUMMARY OF THE INVENTION

The above and other objects and advantages of the invention are achieved by the provision of a light source of the described type and wherein the gas or gas mixture in the bulb includes an enrichment of oxygen and/or an oxygen-containing compound.

To begin with, it has been found by the invention that the generation of a transfer cycle or a transfer function within the bulb of a light source does in the least not inevitably require halogen compounds. Next, it has been found in accordance with the invention that an enrichment of the gas or gas mixture contained in the bulb and consisting of oxygen and/or an oxygen containing compound is likewise able to provide a suitable transfer cycle or a suitable transfer function to return chemical elements that are released from the filament.

It is preferred to add oxygen not in the form of molecular oxygen, but in the form of an oxygen containing inorganic compound, such as NO₂, N₂O, CO, CO₂, or an oxygen-containing organic compound, for example, alcohol, aldehyde, ketone, and carboxylic acid. During the decomposition of the oxygen-containing compound, oxygen is then made available for further reactions during the operation. The quantity of substance of the element oxygen per unit volume, which correlates with the number of oxygen atoms per unit volume, is preferably at least 1×10⁻⁵ mol/l, and very preferably at most 1×10⁻⁴ mol/l. Typically, a quantity of substance ranges from 8×10⁻⁷ to 8×10⁻⁶ mol at 70 ml. In this connection, one may do without halogens or halogen compounds, so that transfer cycles that operate by means of halogen compounds or halogens are not needed.

As an alternative, it is possible to replace transfer cycles that operate by means of halogens or halogen compounds, with other transfer cycles that operate without halogens or halogen compounds. In the end, it is possible to lessen or even totally prevent internal components of the light source from being damaged by halogens. Accordingly, there is no need for costly coatings or materials, which are resistant to damage by halogens.

Consequently, the light source of the invention provides a light source, wherein a high energetic efficiency is achieved with simple and consequently cost-favorable means.

In a preferred embodiment, the bulb also contains a low-molecular hydrocarbon. The low molecular, saturated or unsaturated hydrocarbon preferably contains no more than 4 carbon atoms. Otherwise, the vapor pressure will no longer be adequately high. The partial pressure of the added hydrocarbon is preferably at least 0.1 mbar, and very preferably at most 1.5 mbar.

Specifically, the light source of the invention provides a light source, which permits attaining a mass transfer cycle or a transfer function. Accordingly, it permits returning to and/or into the filament evaporating or released filament material, such as, for example, carbon, boron, or silicon. This occurs preferably with filament materials that are high melting or refractory. In a particularly preferred and durable configuration of a light source, the filament may largely consist of metal carbide, preferably tantalum carbide.

In a particularly reliable manner, a transfer function may be generated by an enrichment or purposeful addition of carbon monoxide as oxygen-containing compound.

With respect to a further advantageous development of the light source, the low molecular hydrocarbon may comprise C₂H₂. Likewise, C₂H₂ is able to return again to the filament, for example, carbon that has evaporated from the filament. However, carbon monoxide and C₂H₂ may also serve at the same time as producers for a transfer function.

In a further advantageous development, the low-molecular hydrocarbon may comprise methane or ethane. When selecting the respective hydrocarbon, it will be necessary to take into account the particular application, for example, the structural form, the desired service life, and the desired output values.

In addition, the gas or the gas mixture in the bulb may include an enrichment of hydrogen. This has shown to be especially effective for providing a transfer function also in combination with enrichments consisting of oxygen and/or an oxygen containing compound and possibly, in addition, of a low molecular hydrocarbon. The partial pressure of the hydrogen (H₂) is preferably at least 10 mbar and very preferably at most 100 mbar.

It is basically possible to introduce into the bulb suitable gases or gas mixtures, which will then be directly suited for providing a transfer function for a chemical element. As an alternative or in addition, however, it is also possible to introduce into the bulb chemical elements or compounds, which react only during the operation of the light source such that the desired atmospheric composition develops in the bulb. Specifically, it is possible to form the enrichment or enrichments by the reaction of suitable chemical elements or compounds in the bulb during the operation of the light source or the heating of the filament.

A further advantageous development permits introducing into the bulb low molecular hydrocarbons together with at least one, preferably volatile, oxygen containing carbon compound or oxygen containing gaseous compound and hydrogen at suitable ratios. Predetermined ratios would need to be adjusted to the particular case of application, for example, structural form, desired service life, and desired output values. The number of the hydrogen, oxygen, or carbon atoms per unit volume that are present in the bulb as a whole, i.e., related to all compounds introduced into the lamp, is preferably within respectively defined ranges. The thus correlating quantities of substance of the element oxygen that is introduced as a whole into the gaseous atmosphere, are preferably in a range from 1×10⁻⁶ mol/l to 10⁻⁵ mol/l, those of the introduced element carbon are preferably from 4×10⁻⁶ mol/l to 4×10⁻⁵ mol/l, and those of the introduced element hydrogen are preferably from 8×10⁻⁴ mol/l to 2×10⁻² mol/l.

In this connection, the at least one oxygen containing carbon compound may include an alcohol, an aldehyde, a ketone, a monocarboxylic acid, or a dicarboxylic acid. The at least one oxygen-containing compound may include CO₂, NO, NO₂, or N₂O.

With respect to a particularly effective transfer function, a hydrogen surplus over the free oxygen may form in the bulb. The ratio of the concentrations of the elements hydrogen and oxygen per unit volume, which are proportional to the number of atoms per unit volume, should preferably be greater than 10:1, and very preferably not greater than 100:1.

Furthermore, with respect to a particularly effective transfer function, the enrichment of oxygen may amount to at least 50 ppm within the atmosphere surrounding the filament.

The foregoing object is furthermore accomplished by a method of providing a transfer function for a chemical element in a light source and including the steps of enriching the gas or gas mixture with oxygen and/or an oxygen containing compound, and possibly in addition with a low molecular hydrocarbon.

As regards the advantages of the method according to the invention, the foregoing description in connection with the light source described therein is herewith incorporated by reference for purposes of avoiding repetitions.

For an explanation and further understanding of the invention, the essential aspects of the invention are one more time presented in the following.

Basically, the invention enables one or more halogenfree mass transfer cycles, for example, for carbon. One of the mass transfer cycles may be based on oxygen containing compounds and/or on oxygen, and possibly in addition on a low molecular hydrocarbon. The transfer function that can be produced in accordance with the invention permits supplying the filament within the bulb with, for example, carbon. With that, it becomes possible to increase the service life of the light source.

It is possible to provide at least one chemical transfer cycle, which does not use halogen compounds, or it is possible to substitute at least one further chemical transfer cycle without halogen compounds for a chemical transfer cycle on the basis of halogen compounds.

This may occur, for example, by purposefully adding at least one oxygen containing compound. With that, it becomes possible to reduce or even totally avoid halogen compounds in the bulb. Basically, the invention can be applied to all light sources or incandescent lamps with high melting or refractory filament materials, as are listed, for example, in the “Handbook of Chemistry and Physics,” published by CRC-Press, 80^{th} edition, Tables of Refractory Materials, chapter 12, pages 207-208, and Tables of Physical Constants or Inorganic Compounds, chapter 4, page 37 et seq.

A particularly suitable embodiment is formed by a light source with a tantalum carbide filament. To generate a halogenfree carbon transfer cycle in the bulb, one may apply the following steps. Besides low molecular hydrocarbons, such as, for example, methane and ethane, one may also introduce into the bulb hydrogen and carbon monoxide. This can occur in different ways.

On the one hand, such a gas mixture of the desired gases may be synthesized and introduced into the bulb. As an alternative or in addition, one may introduce into the bulb other suitable chemical compounds, which react during the operation of the light source such that the desired atmosphere composition develops.

In the last mentioned case, it is possible to introduce into the lamp bulb at certain ratios, for example, low molecular hydrocarbons together with one or more volatile, oxygen containing carbon compounds, for example, water, alcohols, aldehydes, ketones, monocarboxylic acids, dicarboxylic acids, and the like, or with one or more oxygen containing gaseous compounds, for example, CO₂, NO, NO₂, or other “laughing gas derivatives,” and the like, and hydrogen. During the operation of the lamp, other low molecular hydrocarbons, cyanides, NH₄, CO₂, H₂O, and N₂, but primarily CO are able to form among others.

In a preferred embodiment, methane was introduced into the bulb together with hydrogen and acetone and a rare gas at a certain mixing ratio or under certain partial pressures. For the understanding of the invention, the use of rare gases is of no importance, and will therefore be no longer referred to. During the operation of the lamp, H₂O, C₂H₂, small quantities of CO₂, and primarily CO developed. As the operating time increases, methane continues to decompose, and CO continues to build up. As a result of the CO formation, the oxygen binds free carbon, and thus suppresses a sooting of the lamp bulb. The reaction conversions via reaction channels with CO₂ are of no importance because of the small occurrence of CO₂.

The existing dissociated elementary hydrogen primarily reacts with free carbon to form methane and C₂H₂. This can be concluded from the strong sooting of the lamp bulb, which occurs, when hydrogen is no longer present in excess over free carbon.

Since both CO and C₂H₂ exhibit with 1076.5 kJ/mol and 962 kJ/mol a high and even approximately twice as high dissociation energy as all other possible thermal dissociation fragments of the referenced components of the atmosphere, CO is able to dissociate only in the hottest region of the lamp, for example, on the heated tantalum carbide filament, and to release carbon to the filament. The freed oxygen will then react predominantly with the free carbon, which evaporates from the filament, to form CO. Same is able to return the carbon again to the filament, thereby forming a CO cycle.

The reaction of the free oxygen with the tantalum of the filaments does not occur in the strongly reducing hydrogen atmosphere or because of the adjusted great hydrogen surplus. Because of the high temperature gradient from the heated filament toward the bulb wall of the light source, an effective thermal diffusion is able to occur, which concentrates lighter atoms or molecules, such as hydrogen, around the filament, whereas heavier atoms or molecules, such as oxygen, are pushed away from the heated filament. Regardless of the introduced oxygen quantities, the oxygen does not attack the tantalum carbide filament. In addition, one observes only a very limited formation of water and CO₂, which confirms the assumption of the predominant formation of CO by the free oxygen. Besides that, a certain formation of CO may also occur via the reaction of methane dissociation fragments, such as, for example, CH with OH from the reaction of free oxygen or from the thermal dissociation of water.

In addition to CO, C₂H₂ is also able to return again to the filament carbon that has evaporated from the filament. However, because of the low binding energy of CH (338.1 jK/mol) C₂H₂ totally dissociates on the filament into carbon and hydrogen. The free hydrogen is then again able to combine with the free carbon that has evaporated from the filament, to form CH, which is then able to react further to methane or again to C₂H₂. The latter is then again able to transfer carbon to the filament. Since methane predominantly releases hydrogen during its thermal dissociation, its CH dissociation fragments will also be able to form C₂H₂. Consequently, the carbon transfer by the dissociation of C₂H₂ proceeds together with the methane dissociation, thereby forming a C₂H₂/CH₄ cycle.

The procedure of introducing according to the invention in a purposeful manner oxygen or oxygen containing compounds into the methane-hydrogen atmosphere permits establishing inside a lamp a CO cycle and possibly in addition a C₂H₂/CH₄ cycle for the return of evaporated carbon to the tantalum carbide filament. With that, it becomes possible to lengthen the service life of lamps with refractory filaments, and to suppress or even totally avoid transfer cycles on the basis of halogen compounds or halogen.

### BRIEF DESCRIPTION OF THE DRAWING

There exist various possibilities of improving and further developing the teaching of the present invention in an advantageous manner. To this end, one may refer to the following description of a preferred embodiment of the invention with reference to the drawings. In conjunction with the description of the preferred embodiment of the invention with reference to the drawing, also generally preferred improvements and further developments of the teaching are described. In the drawing, the only

FIGURE is a schematic side view of an embodiment of a light source according to the invention.

### PREFERRED EMBODIMENTS OF THE INVENTION

The only FIGURE illustrates a schematic side view of an embodiment of the light source according to the invention. The light source comprises a heatable filament 1, with the filament 1 being arranged in a bulb 2. The heating of the filament 1 occurs via electric contacts 3 and 4. Furthermore, the bulb 2 contains a gas or gas mixture, which is suitable for providing a transfer function for returning again back to and/or into the filament 1 at least one chemical element that has released from the filament 1. With respect to a high energetic efficiency with simple means, the gas or the gas mixture contains an enrichment of oxygen and/or an oxygen containing compound. It is preferred to add oxygen not in the form of molecular oxygen, but in the form of an oxygen containing inorganic compound, such as NO₂, N₂O, CO, CO₂, or in the form of an oxygen containing organic compound, for example, alcohol, aldehyde, ketone, and carboxylic acid. When the oxygen-containing compound decomposes, oxygen will be made available for the further reactions during the operation. The quantity of substance of the element oxygen per unit volume, which correlates with the number of oxygen atoms per unit volume, is preferably at least 1×10⁻⁵ mol/l, and very preferably at most 1×10⁻⁴ mol/l. Typically, a quantity of substance ranges from 8×10⁻⁷ mol to 8×10⁻⁶ mol at 70 ml.

The filament 1 largely consists of tantalum carbide. The oxygen containing compound includes carbon monoxide.

### EXAMPLE 1

The lamp bulb of soft glass has a volume of 70 ml. The coiled filament consisting of tantalum carbide is mounted to power supplies of molybdenum. The temperature of the illuminating body amounts to 3600 K, the average bulb temperature is about 400° C. The composition of the gaseous phase for this lamp is as follows:
3 bar Xe+0.1 bar H₂+5×10⁻⁵ bar C₂H₂+5×10⁻⁵ bar CH₃COCH₃.

### EXAMPLE 2

The lamp bulb of quartz glass has a volume of 0.5 ml. The illuminating body consists of tantalum carbide; the rods in the lower portion are of tantalum. The illuminating body is operated at 3600 K; the average bulb temperature is at 500° C. The composition of the gaseous phase for this lamp is as follows:
1 bar Xe+0.05 bar H₂+1×10⁻⁵ bar C₂H₂+5×10⁻⁵ bar CH₃COCH₃.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A light source comprising a bulb, a heatable filament comprising a metal carbide mounted within the bulb, and a gas or gas mixture enclosed within the bulb which is suited for providing a transfer function for returning again back to and/or into the filament at least one chemical element that has been released from the filament, and wherein the gas or the gas mixture includes an enrichment of oxygen and/or an oxygen containing compound, with the enrichment of oxygen comprising at least 50 ppm within the gas or gas mixture.

2. The light source of claim 1, wherein the filament comprises tantalum carbide.

3. The light source of claim 1, wherein the oxygen-containing compound contains carbon monoxide.

4. The light source of claim 1, wherein the gas or gas mixture comprises a low molecular hydrocarbon.

5. The light source of claim 4, wherein the low molecular hydrocarbon comprises C₂H₂.

6. The light source of claim 4, wherein the low molecular hydrocarbon comprises methane or ethane.

7. The light source of claim 1, wherein the gas or gas mixture contains an enrichment of hydrogen.

8. The light source of claim 1, wherein the enrichment is formed by reacting suitable chemical elements or compounds in the bulb during the operation of the light source or during the heating of the filament.

9. The light source of claim 1, wherein a low molecular hydrocarbon is introduced into the bulb together with at least one oxygen containing carbon compound or oxygen-containing gaseous compound and hydrogen at predetermined ratios.

10. The light source of claim 9, wherein the oxygen containing carbon compound is selected from the group consisting of an alcohol, an aldehyde, a ketone, a monocarboxylic acid, a dicarboxylic acid, and mixture thereof.

11. The light source of claim 1, wherein the oxygen containing compound comprises CO₂, or NO, or NO₂, or N₂O.

12. The light source of claim 1, wherein a hydrogen surplus over free oxygen is present in the bulb.

13. A method of producing a light source comprising a bulb and a heatable filament comprising a metal carbide mounted within the bulb, including introducing a gas or gas mixture into the bulb and which is suited for providing a transfer function for returning again back to and/or into the filament at least one chemical element that has been released from the filament, and further enriching the gas or gas mixture with oxygen or an oxygen containing compound so that the enrichment of oxygen amounts to at least 50 ppm within the atmosphere surrounding the filament.

14. The method of claim 13 wherein the step of enriching the gas or gas mixture comprises reacting suitable chemical elements or compounds in the bulb during operation of the light source or during the heating of the filament.

15. The method of claim 13 wherein the step of introducing a gas or gas mixture into the bulb includes introducing a low molecular hydrocarbon into the bulb.
